(19) United States
(12) Patent Application Publication
(10) Pub. No.: US 2016/0359283 A1
(43) Pub. Date: Dec. 8, 2016

(54) ELECTROMECHANICAL ADAPTER FOR ELECTRIFIED TRACKS

(71) Applicant: A.A.G. STUCCHI S.R.L., Olginate (IT)

(72) Inventor: Aristide STUCCHI, Lecco (IT)

(73) Assignee: A.A.G. STUCCHI S.R.L., Olginate (IT)

(21) Appl. No.: 15/175,125

(22) Filed: Jun. 7, 2016

(30) Foreign Application Priority Data
Jun. 8, 2015 (IT) 102015000021172

(51) Int. Cl. H01R 25/14

(52) U.S. Cl. CPC H01R 25/145

(57) ABSTRACT

An electromechanical adapter for electrified tracks, which comprises an adapter body which is adapted to be coupled so as to be concealed within an electrified track, the adapter body comprising internally the components required for the power supply and control of lighting appliances, at least one lighting appliance being adapted to be connected to said electromechanical adapter.

The present invention relates to an electromechanical adapter for electrified tracks. More specifically, the invention relates to an electromechanical adapter for the “concealed” mounting of an electrified track.

As is known, electrified tracks are usually used for transporting current from one point to another of an environment so as to be able to connect for example lighting appliances and the like without having to install wiring.

Concealed or exposed adapters are currently known which have components for power supply and/or control of lighting appliances arranged inside an adapted box which is positioned in view.

Such solution is not appreciated from an aesthetic point of view, however.

Furthermore, there are concealed adapters with components for power supply and/or control integrated in the lighting appliance that is to be connected to the adapter.

In such case, however, the lighting appliance cannot be a standard appliance and instead it must be specially adapted for use with adapters that are adapted to be applied to electrified tracks.

Even furthermore, if the components for power supply and/or control of the lighting appliance are accommodated in the lighting appliance proper, this contributes to increasing the dimensions of the lighting appliance, therefore not meeting the miniaturization needs that are strongly felt by market trends.

Furthermore, for conventional lighting appliances that are connected with connecting cables, there is the problem of kinking of the wires if the lighting appliance is to be provided with a permitted complete rotation of 360°.

The aim of the present invention is to provide an electromechanical adapter for electrified tracks that can be inserted so as to be concealed within an electrified track and which allows the coupling of lighting appliances without the need for wiring or the like.

Within this aim, an object of the present invention is to provide an electromechanical adapter for electrified tracks that can be used with standard lighting appliances.

Another object of the present invention is to provide an electromechanical adapter for electrified tracks that can adapt new and updated versions of the lighting appliance in each case without modifying the adapter or the electrified track.

Another object of the present invention is to provide an electromechanical adapter for electrified tracks that is highly reliable, easily and practically implemented and low cost.

This aim and these and other objects which will become better apparent hereinafter are achieved by an electromechanical adapter for electrified tracks, which comprises an adapter body which is adapted to be coupled so as to be concealed within an electrified track, characterized in that the adapter body comprises internally the components required for the power supply and control of lighting appliances, at least one lighting appliance being adapted to be connected to said electromechanical adapter.

Further characteristics and advantages of the invention will become better apparent from the description of a preferred, but not exclusive, embodiment of the adapter according to the present invention, which is illustrated by way of non-limiting example in the accompanying drawings wherein:

FIG. 1 is a perspective view of the electromechanical adapter according to the present invention, with a closure element partially exploded;

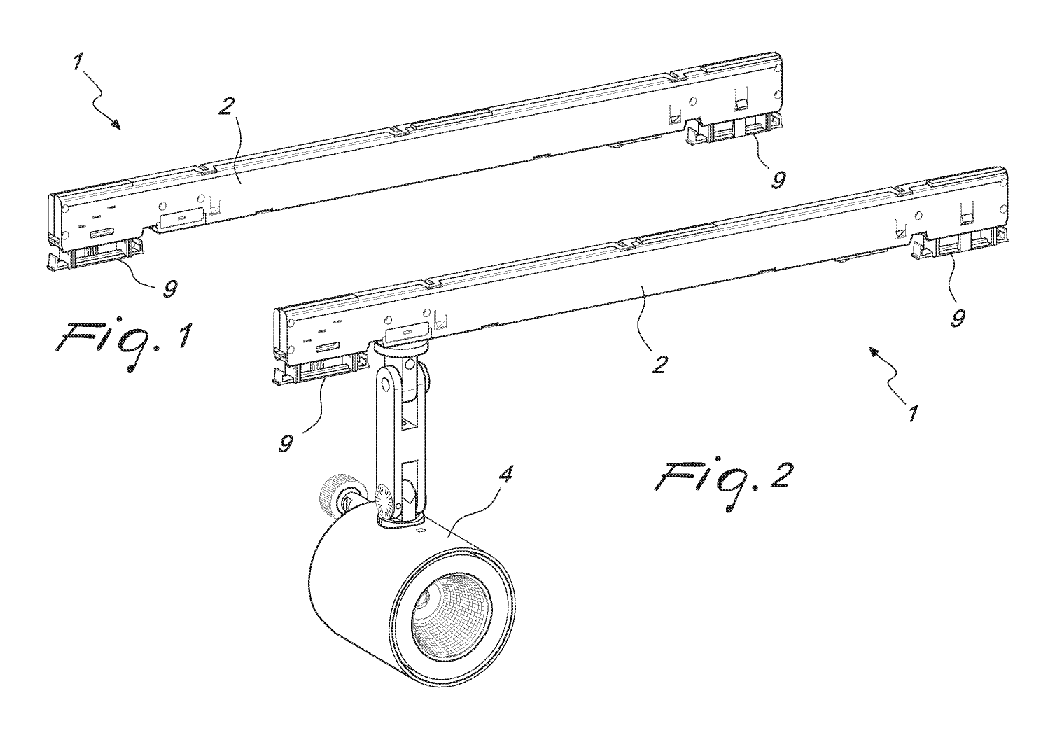

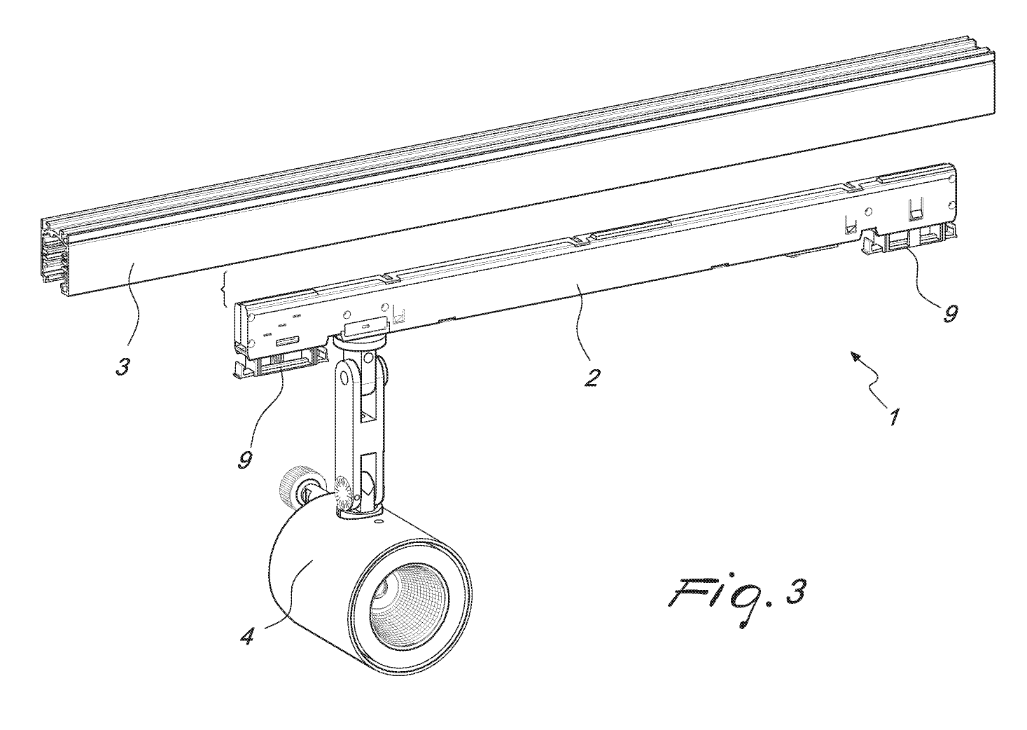

FIG. 2 is a perspective view of the electromechanical adapter according to the invention with a lighting appliance coupled thereto;

FIG. 3 is an exploded perspective view of the adapter according to the invention, of the corresponding lighting appliance, and of the electrified track;

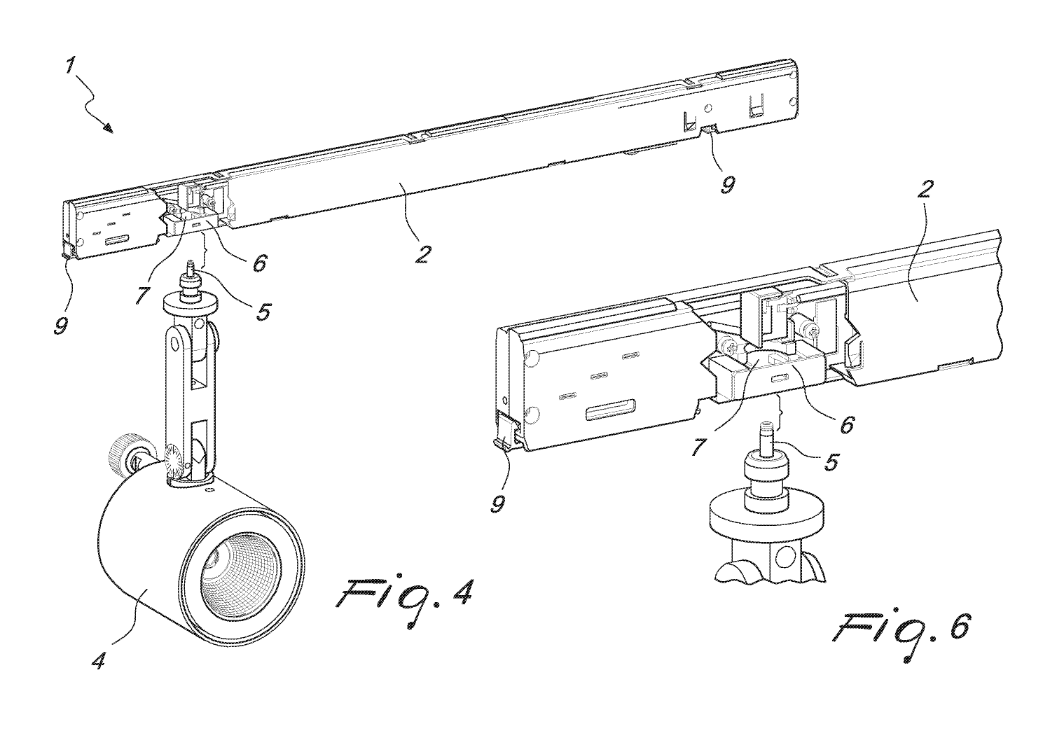

FIG. 4 is an exploded perspective view of the lighting appliance and of the electromechanical adapter according to the invention;

FIG. 5 is a perspective view of the lighting appliance coupled to the electromechanical adapter which in turn is inserted so as to be concealed in the electrified track;

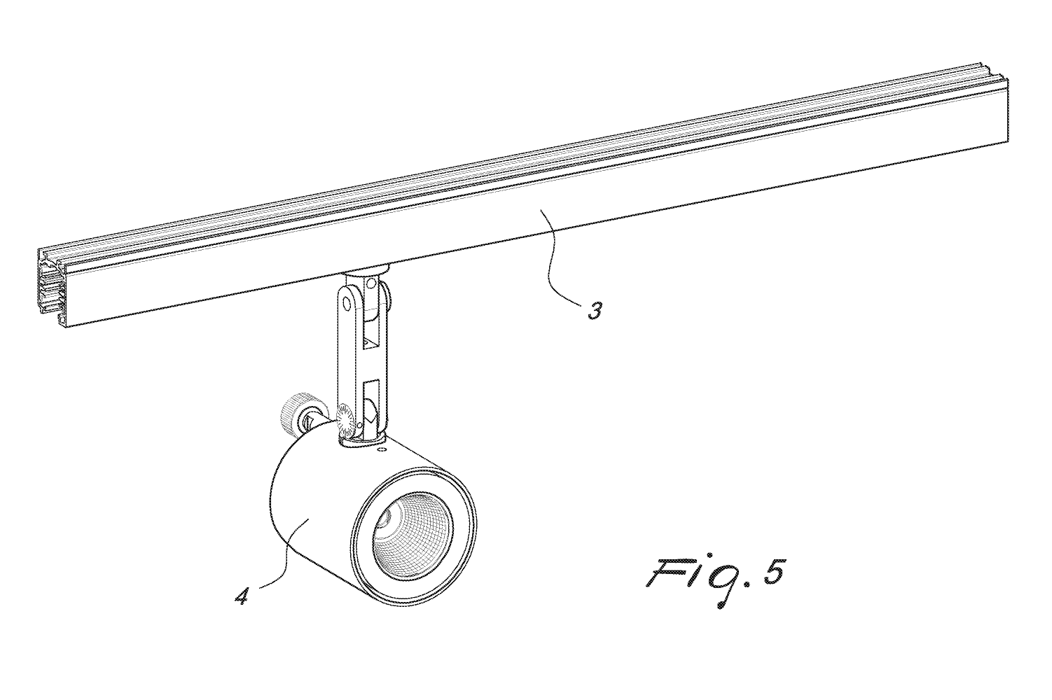

FIG. 6 is an enlarged perspective view of the coupling between the lighting appliance and the electromechanical adapter according to the invention;

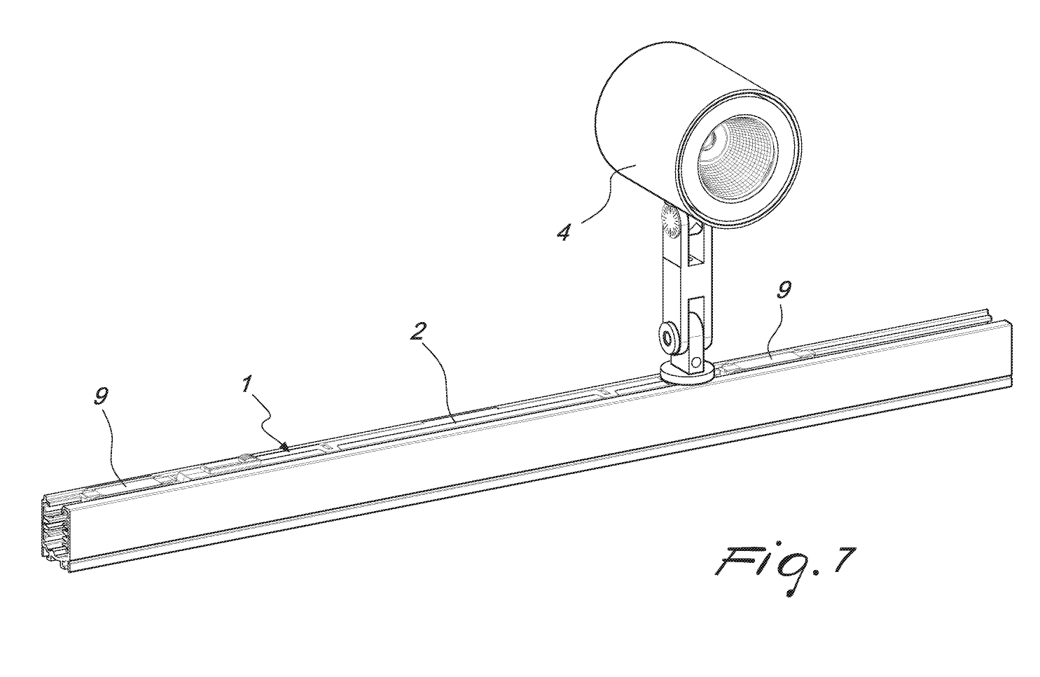

FIG. 7 is a perspective view from below of the electromechanical adapter according to the invention, coupled so as to be concealed in the electrified track and with the lighting appliance engaged thereto;

FIG. 8 is a perspective view of the electromechanical adapter according to the invention, with the closure elements partially exploded;

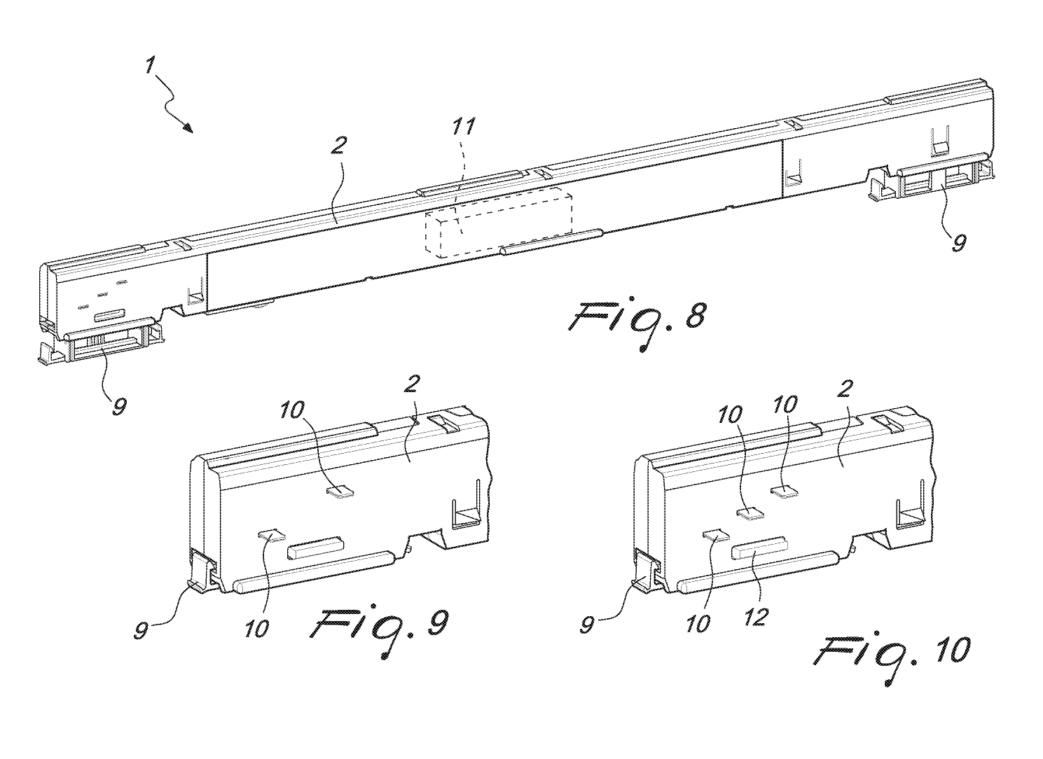

FIG. 9 is a perspective partial view of a detail of the electromechanical adapter according to the invention, in a first embodiment thereof;

FIG. 10 is a perspective partial view of a detail of the electromechanical adapter according to the invention, in a second embodiment thereof.

With reference to the figures, the electromechanical adapter according to the present invention, generally designated by the reference numeral 1, comprises a body shaped substantially like a parallelepiped 2 which can have four contacts or six contacts, for example, and is adapted to be inserted so as to be concealed in an electrified track 3.

The adapter 1 comprises the coupling of a lighting appliance 4. According to the invention, the electromechanical adapter body 2 comprises internally the components required for the power supply and/or control of the lighting appliance 4 including in wireless mode (for example LED drivers, DALI LED drivers, wireless receivers and the like).

The reference numeral 11 designates, in FIG. 8, the electronics for power supply and control.

The connection between the electromechanical adapter body 2 and the lighting appliance 4 must be provided by way of plug-and-socket jack connectors, 5, where the reference numeral 6 on the electromechanical adapter 2 designates the coupling seat 7 of the jack connector 5.

In this manner, the lighting appliance or lighting appliance 4 is an entirely standard appliance, without electronic components for power supply and/or control, differing only from conventional lighting appliances by the presence of the jack connector 5.

The body 2 of the adapter is provided, at at least one end thereof, with contacts 10 and with a stop element 12.

There is a closure element 9 for closing the end of the body 2 of the adapter in a downward region and its insertion to close the end causes the egress of the contacts 10 and of the stop element 12, as shown in the enlargements in FIGS. 9 and 10 which show the variants with four and with six contacts, respectively.

Use of the concealed adapter gives the electrified track a design that is attractive and lightened, in line with market trends, thus placing the emphasis on the design of the lighting appliance 4, which therefore is allowed greater freedom and flexibility than the solutions currently known with standard rails.

Furthermore, the integration of components for power supply and/or control of lighting appliances and of an electromechanical adapter fully meet the need for miniaturization which is strongly felt by the market.

The engagement of the lighting appliance with the adapter by way of plug-and-socket jack connectors renders the mounting of the lighting appliances simpler and quicker.

Furthermore, this allows a complete 360° rotation of the lighting appliance 4, thus eliminating all the limitations present in the standard solutions available on the market, which are imposed by the presence of connecting cables and the kinking thereof during the rotation of the lighting appliance 4, or of blocking systems present on adapters which limit the rotation angle of the lighting appliance.

Even furthermore, the electromechanical adapter according to the invention facilitates the reduction of stock for makers of lighting appliances, who can mount the lighting appliances to the adapter as the last step of all and who can keep stock on hand of the adapter only, thus avoiding any obsolescence of the stock of lighting appliances.

It follows from this that the management of shipments is easier, since the adapter and the lighting appliance can be shipped separately.

Finally, the adapter according to the invention makes it possible in each case to mount more recent versions of the lighting appliance (particularly for improved electronics or a new version on the market), thus meeting the market need to have products that can always be in step with the times.

In practice it has been found that the adapter according to the present invention fully achieves the set aim and objects.

The adapter thus conceived is susceptible of numerous modifications and variations, all of which are within the scope of the appended claims.

Moreover, all the details may be substituted by other, technically equivalent elements.

In practice, the materials used, as well as the contingent shapes and dimensions, may be any according to requirements and to the state of the art.

The disclosures in Italian Patent Application No. 102015000021172 (UB2015A001136) from which this application claims priority are incorporated herein by reference.

What is claimed is:

1. An electromechanical adapter for electrified tracks, which comprises an adapter body which is adapted to be coupled so as to be concealed within an electrified track, wherein the adapter body comprises internally the components required for the power supply and control of lighting appliances, at least one lighting appliance being adapted to be connected to said electromechanical adapter.

2. The electromechanical adapter according to claim 1, wherein said at least one lighting appliance is provided with a plug-and-socket jack connector for coupling to said electromechanical adapter.

3. The electromechanical adapter according to claim 1, wherein said adapter is an adapter with four or six contacts.

4. The electromechanical adapter according to claim 1, wherein said lighting appliance is coupled to said adapter by way of said jack in a seat defined within said adapter.

5. The electromechanical adapter according to claim 3, wherein said adapter body comprises, at at least one end thereof, an element for closing the adapter body, which is adapted to close said end in a lower region and to allow said contacts to exit from the lateral surface of said end.

6. An electrified track, comprising an electromechanical adapter according to claim 1.
